(19) United States
(12) Patent Application Publication
(10) Pub. No.: US 2009/0064257 A1
(43) Pub. Date: Mar. 5, 2009

(54) COMPACT GRAPHICS FOR LIMITED RESOLUTION DISPLAY DEVICES

(76) Inventor: Hubert OEHM, Vomp (AT)

Correspondence Address: Pearl Cohen Zedek Latzer, LLP, 1500 Broadway, 12th Floor, New York, NY, 10036, US

(21) Appl. No.: 12/146,201

(22) Filed: Jun. 25, 2008

(30) Foreign Application Priority Data
Sep. 5, 2007 (IL) 185742

(51) Int. Cl. H04N 7/173

(52) U.S. Cl. 725/119

(57) ABSTRACT

A method for compactly communicating a scene of graphical content from a server to a display device of known display characteristics is disclosed. The scene comprises scene data. The method comprises determining if the scene data already exists at the display device. If it is determined that the scene data already exists at the display device, refraining from communicating the scene data, and if it is determined that the scene data does not exist at the display device, communicating the scene data to the display device.

### CROSS REFERENCE

This application claims the benefit under 35 U.S.C. §119 of IL patent application No. 185742, filed Sep. 5, 2007.

### FIELD OF THE INVENTION

The present invention relates to video streaming. More particularly the present invention relates to system and method for providing compact graphical content associated with video streaming for end user display devices with limited communication bandwidth and limited display capabilities.

### BACKGROUND OF THE INVENTION

Traditional TV broadcast involves broadcasting audio and video content on-air (or through cables) to a plurality of users. This means that each user can intercept a broadcast at any given time and view the content as it is being broadcasted. The user has no control and all he (or she) can do is to decide whether to view it or change to another channel (in multiple channel broadcasting).

Video streaming is a widely used method for providing online video capabilities. Essentially video streaming deals with accessing a video (and audio) file located on a remote location (typically a webpage) and playing that file on a local end-user display online (as opposed to downloading the file and playing it off-line) while video data is being streamed to the end-user machine facilitating continuous video.

Video and audio data (we refer both to video and audio streaming as “video streaming” throughout the present specification) are streamed from a remote server to the end-user. As the multimedia stream reaches the end-user device it is played in real-time (or almost real-time) while data is being received.

Video streaming involves using compressed multimedia files. Typically the most important video codec standards in video streaming are H.261, H.263, MJPEG, MPEG1, MPEG2 and MPEG4 (the last three in particular are very popular).

Generally video streaming can be found in closed-loop intranets but video streaming is increasingly becoming a main entertainment technology over the Web and other large networks.

The quality of video streaming is dependent on bandwidth. In order to reduce the amount of data transferred compression techniques are used. In the MPEG format a Video Elementary Stream (VES) is subjected to GOP (Group of Pictures) encoding. To deal with temporal redundancy, MPEG divides the frames into groups, each referred to as a “group of pictures,” or GOP. A VES is made up of I, P and B type pictures. An I picture (I stands for Intracoded picture) contains information of a whole new frame and is used as reference in the reconstruction of either P or B pictures, whereas a P (P stands for Predicted picture) picture contains information on several consecutive intermediate frames sharing information from the I picture. A P picture supports forward prediction from a previous picture. A B picture (B stands for Bi-directional prediction picture) contains only information of a single intermediate frame. A B picture is a forward, backward or bi-directional picture, referring to other I and P pictures. For example, the extent of the damage caused by a lost packet depends on its location: if the packet is inside an I picture, artifacts will be visible until the showing of the next I picture—usually about 0.5 second. If the lost packet is in P picture, the damage will be for about 3 pictures (frames) duration (typically 120 mSec), and if in B picture, only for the duration of that picture (typically 40 mSec).

As video streaming is aimed at providing a multiple of users access to video content (each user may select video content and view it separately on his display machine), bandwidth is a main concern. As there are many viewers attempting to view various contents at the same time, the overall bandwidth determines how many user can simultaneously access the service.

As bandwidth is a main concern, video streaming techniques involve seeking to minimize the volume of video data being transferred while at the same time trying to preserve video and audio qualities.

While bandwidth is a main concern in all video streaming applications it is crucial in applications designed for small end-user devices, typically hand-held devices, which have very small displays (typically 1-3 inches (displays), such as mobile phones, PDA, hand-held game consoles, laptops with small display and similar devices. The display screen in those devices has relatively low resolution (typically 320×200, 320×240, 176×220) that substantially degrades the quality of text, graphics and animation (hereinafter referred to as “graphical content”) displayed on these devices, down to a level that renders viewing this graphical content impossible. These devices are referred to hereinafter as “limited resolution display devices” (LRDD in short).

Furthermore, LRDDs comprise different kinds of hardware, which may operate with different screen size, screen resolutions, screen color depths, available memory, CPU types, existence and type of graphic accelerators (polygon render capabilities), types of graphical software library (for example Open GL, DirectX), supported languages, type of operating system-hereinafter referred to as “display characteristics” or “graphical characteristics” (in the context of the present invention the display characteristics that is of interest deals with hardware or software characteristics that influences the display quality).

Graphical content associated with video streaming typically comprises graphic elements, which are shown and/or animated on portions of the screen over displayed video content. This can, for example, consist of a text data, subtitles, score, statistics and other information tables (in broadcasts of sport events, for example), name and title of a person being interviewed, station logo, animations and other information.

Conventionally, in TV broadcasts graphical content was generated and combined with video and was then broadcasted as integrated video content to the end users, where each user would pick up the transmission and display it on his (or hers) TV screen.

With respect to LRDD the end result of conventional transmission is poor. Since the resolution on the client screen is lower than the source resolution, the text may be illegible. The present invention is aimed at improving legibility and overall visibility of graphical content.

In recent developments in video streaming (MPEG4), it was suggested to treat graphical content as a different layer, in which case graphical content is sent separately as digital information and not as combined graphics with the video content, and the end user machine receives this information and combines it on the user's display device.

Graphical content is either rendered on the host server, and transmitted rendered to the clients, or, alternatively, graphical content is sent as digital vector information to the clients where it is rendered locally (for example, Macromedia Flash™ approach).

It is an object of the present invention to provide methods for providing compact graphical content for LRDD, reducing video-streaming data transfer while maintaining good quality content broadcast.

Presently video streaming content for LRDDs is provided regardless the hardware displaying it. LRDDs include an application for down-scaling which scales down the video content to facilitate displaying it properly on the small display screen. This simple tool shrinks video data while loosing a lot of information in the process.

An object of the present invention is to provide system and method for generating graphical content that is suited for display on a specific display device.

Another object of the present invention is to provide system and method for generating graphical content for various end-user display devices.

Yet another object of the present invention is to reduce data transmission of graphical elements without degrading display quality.

Other advantages and objects will become apparent after reading the present specification and considering the accompanying figures.

### SUMMARY OF THE INVENTION

There is thus provided, in accordance with a preferred embodiment of the present invention, a method for compactly communicating a scene of graphical content from a server to a display device of known display characteristics, the scene comprising scene data, the method comprising determining if the scene data already exists at the display device, wherein if it is determined that the scene data already exists at the display device, refraining from communicating the scene data, wherein if it is determined that the scene data does not exist at the display device, communicating the scene data to the display device.

Furthermore, in accordance with some preferred embodiments of the present invention, the scene data comprises one or more increments of a greater scene data.

Furthermore, in accordance with some preferred embodiments of the present invention, the step of determining if the scene data already exists at the display device comprises:

requesting from the display device an indication on scene data that exists locally on the display device;

comparing the scene data with the scene data that exists locally on the display device to determine what scene data does not exist on the display device; and

communicating the scene data that does not exist on the display device to the display device.

Furthermore, in accordance with some preferred embodiments of the present invention, the step of determining if the scene data already exists at the display device comprises:

based on information on scene data already communicated to the display device that was previously saved, comparing the scene data with the information on the scene data that was saved to determine what portion of the scene data does not exist on the display device;

communicating the scene data that does not exist on the display device to the display device; and

saving information on the communicated scene data for future communication of scenes.

Furthermore, in accordance with some preferred embodiments of the present invention, the method further comprises, based on the knowledge of the display characteristics the saved information on the communicated scene data, saving data corresponding specifically to the data which the display device maintains.

Furthermore, in accordance with some preferred embodiments of the present invention, the method comprises maintaining a memory replica of a memory of the display device.

Furthermore, in accordance with some preferred embodiments of the present invention, the memory replica is based on knowledge of the LRDD characteristics.

Furthermore, in accordance with some preferred embodiments of the present invention, the memory replica is based on knowledge of the type and size of the memory of the display device.

Furthermore, in accordance with some preferred embodiments of the present invention, the scene data comprises outline data and specific data.

Furthermore, in accordance with some preferred embodiments of the present invention, the specific data is sent in increments.

Furthermore, in accordance with some preferred embodiments of the present invention, the step of determining if the scene data already exists at the display device comprises sending an inventory file describing the content of the scene, checking what is stored in the display device and sending a download request to the server indicating which portions of the scene data are missing on the display device.

Furthermore, in accordance with some preferred embodiments of the present invention, there is provided a system for compactly communicating a scene of graphical content from a server to a display device of known display characteristics, the scene comprising scene data, the system comprising:

a scene generator for generating the scene;

a processor for determining if the scene data already exists at the display device; and

a graphics server for transmitting the scene data to the display device if it is determined that the scene data does not exist at the display device, communicating the scene data to the display device.

Furthermore, in accordance with some preferred embodiments of the present invention, the scene data comprises one or more portions of a greater scene data.

### BRIEF DESCRIPTION OF THE DRAWINGS

In order to better understand the present invention, and appreciate its practical applications, the following Figures are provided and referenced hereafter. It should be noted that the Figures are given as examples only and in no way limit the scope of the invention. Like components are denoted by like reference numerals.

FIG. 1 illustrates a system for providing independent graphical data synchronized with video streaming data, designed to be displayed on a specific type of a display device, according to a preferred embodiment of the present invention.

FIG. 2 illustrates an end-user LRDD adapted to cooperate with a system for generating graphical content such as the system displayed in FIG. 1, according to a preferred embodiment of the present invention.

FIG. 3 illustrates a system for providing independent graphical data synchronized with video streaming data, designed to be displayed on a specific type of a display device, according to another preferred embodiment of the present invention.

FIG. 4 illustrates an end-user LRDD adapted to cooperate with a system for generating graphical content, such as the system displayed in FIG. 3, according to another preferred embodiment of the present invention.

FIG. 5 illustrates an end-user LRDD (as shown in FIG. 2) adapted to cooperate with a system for generating compact graphical content according to a preferred embodiment of the present invention, with a memory of specific type and size.

FIG. 6 illustrates an end-user LRDD (as shown in FIG. 4) adapted to cooperate with a system for generating compact graphical content according to a preferred embodiment of the present invention, with a memory of specific type and size.

FIG. 7 illustrates a system (similar to the system shown in FIG. 1) for providing compact graphical data synchronized with video streaming data, designed to be displayed on a specific type of a display device, according to a preferred embodiment of the present invention, with client memory replica.

FIG. 8 illustrates a system (similar to the system shown in FIG. 3) for providing compact graphical data synchronized with video streaming data, designed to be displayed on a specific type of a display device, according to another preferred embodiment of the present invention, with client memory replica.

### DETAILED DESCRIPTION OF PREFERRED EMBODIMENTS

The present invention introduces a system and method for generating graphical content to be overlaid on video content that is suited for display on a specific display device, or for stand-alone graphical applications.

At the heart of the present invention lies the realization that there is a multitude of end-user display devices, each having their own display characteristics. In order to address this problem a system according to a preferred embodiment of the present invention generates specific graphical content for a specific end-user LRDD.

A main aspect of the present invention is automatic generation of graphical content specifically designed for a specific type of LRDD. This means that graphical content will be generated differently depending on the display characteristics of a particular end-user device.

A system according to a preferred embodiment of the present invention comprises a graphical content scene generator that allows an operator to produce graphical content, using a library (database) of graphical elements, which is exported to a scene file containing vector information relating to the graphical content. Alternatively, an operator is not involved, and instead automated information is used in the generation of the scene (for example stock data).

A “scene” refers to the graphical content that is superimposed on video content. A scene file contains everything necessary to render the scene and animate it on the client display: camera (position, field of view), lights, transformation tree, materials, textures, images, 3D objects, animations, scripts for interactivity, etc. Alternatively the scene is not superimposed on video content, and is solely displayed.

In the process of generating the scene file (which is called “exporting”) the scene generator refers to a database of LRDDs, which lists display characteristics of LRDDs (for example, types of LRDDs that are available, registered or on-line) and generates a file that is formatted and specifically suited for each kind of all display devices (all the devices having the same specific display characteristics). By “exporting” it is meant that the scene which is in memory is saved into a file which the client can read and render. Exporting also does all the optimizations for the client: scaling of images, vertex processing, animation sampling, etc.

If there are various LRDDs with different display characteristics that are registered for the service or appear on-line, the scene generator would automatically generate different scene files for each set of display characteristics.

According to a preferred embodiment of the present invention, a video server sends to on-line clients the video stream along with the graphical content in its vector format (the scene file), each client receiving a scene file suitable for his own LRDD display characteristics, and rendering it locally using a rendering application existing in that specific LRDD device. As each device gets a graphical content file that is tailor-made and customized, and renders it locally, there is no accidental or random data loss involved, and consequently the quality of the graphical content display is optimized. In another preferred embodiment of the present invention the graphical content is generated and transmitted to the client separately from the video streaming content, and is merged on the client device. In yet another preferred embodiment of the present invention graphical content is sent to a client device without any video streaming content, to be used for various application (for example, voting).

In essence the transmitted data according to the present invention is characterized as not being screen shots or video clips, rather data that allows graphics to be reconstructed on the end-user display device (the LRDD).

The system and method of the present invention provides, in effect, graphics engine for any viewer. Not only it is particularly suited for each type of display device, but it may also be targeted specifically to each individual who is a client of the provided service.

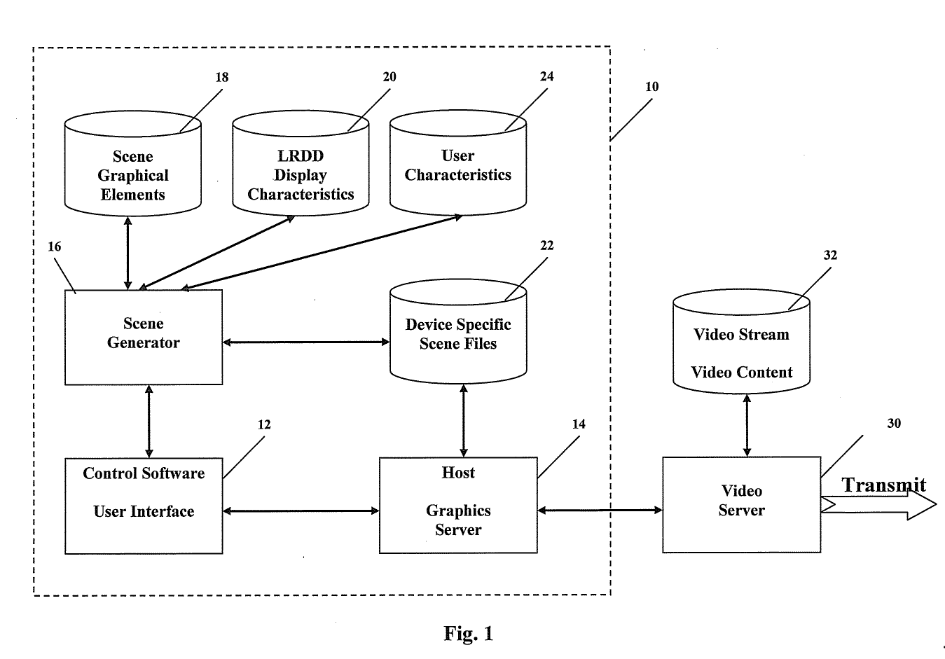

Reference is made to FIG. 1 illustrating a system 10 for providing independent scene files with video streaming data for specific kinds of LRDDs, according to a preferred embodiment of the present invention.

The system generally comprises a scene generator 16, for generating a scene file. An operator through control user interface 12 uses scene graphical elements database 18 to design a scene. An example of such a scene generator is Viz|Engine™ (by Vizrt Ltd., Israel). Examples of control interfaces are: Viz|Trio™ and Viz|Content Pilot™ for live productions (e.g. news, sport event), and Viz|Multi Channel™ or Viz|Ticker 3D™ for automated production (e.g. new ticker, automated financial graphics), all by Vizrt Ltd, Israel.

A graphics host server 14 may maintain a list of online (or registered) LRDDs for which the graphical content is generated. An example of such a graphical server is Viz|MPS™ (by Vizrt Ltd., Israel). The scene generator 16 refers to LRDD database 20 containing a list of display characteristics relating to various LRDDs, and depending on the LRDD type of the device for which the video content is prepared formats the scene to suit the graphical characteristics of a specific online or registered LRDD.

The scene is exported into a scene file database 22, which may be saved for additional future use.

The graphics host server 14 manages the scene generation process for the specific LRDD and transfers the specific scene file (or files) to a video server 30, that takes video stream content from a video stream database 32 (or live video feed) and transmits the video stream together with the scene file (that contains the graphical content in vector format, formatted for each kind of the display devices).

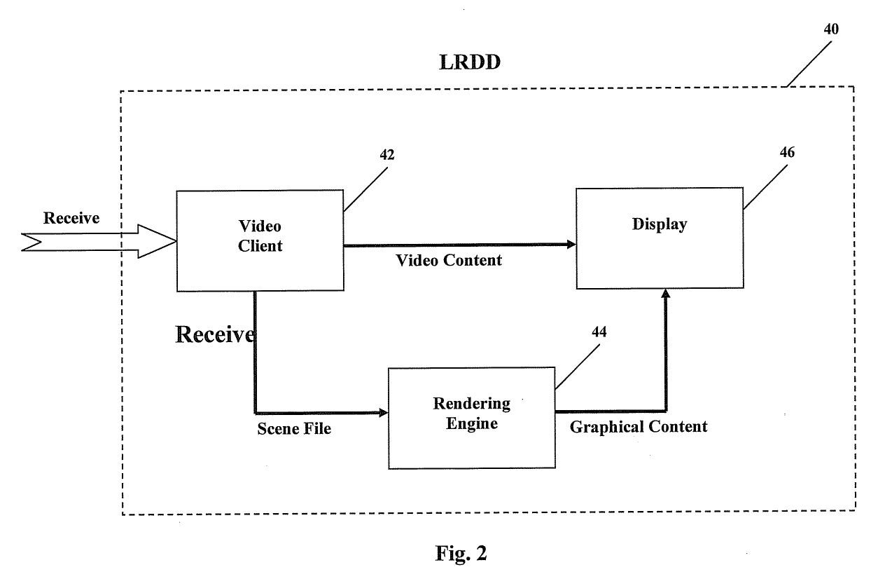

FIG. 2 illustrates an end-user LRDD 40 adapted to cooperate with a system for generating graphical content according to a preferred embodiment of the present invention, such as the system displayed in FIG. 1.

The combined video content is received by video client 42, which sends the scene file to rendering engine 44, which renders the scene file to graphical content so that both the video stream and the graphical content are displayed on display 46.

The graphical content is streamed along with the video content and therefore inherently synchronized. Typically, the chosen video streaming format handles latencies that may be introduced between the video content and graphical content.

The client application is used to render the scenes on the client display device, rendering the graphical content as a layer on top of the video layer. It is optimized for each specific client, and the scenes are exported to the client, thus ensuring high-quality render performance.

The client application may also includes control features, defining logic “above scene level” which is used to hard code specific properties, such as server host name, IP Address, etc.

The client application runs on the user device and communicates with the server. It is designed to be lightweight and small so as to allow portability and maintain resource efficiency.

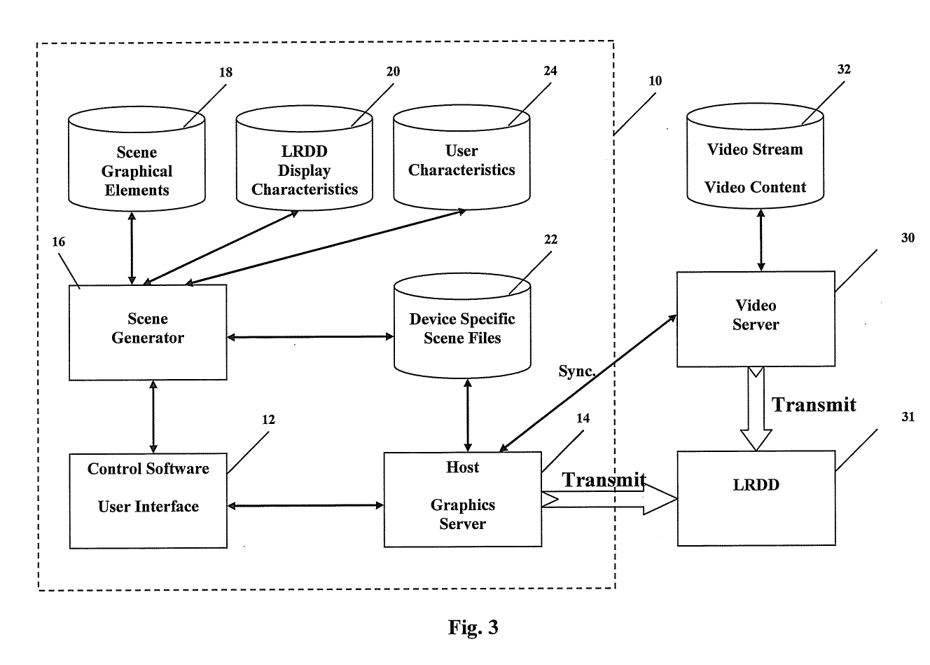

Reference is made to FIG. 3, illustrating a system for providing independent graphical data synchronized with video streaming data, designed to be displayed on a specific type of a display device, according to another preferred embodiment of the present invention. In this embodiment the scene files generated by system 10 are transmitted to client 31 separately from the video stream. This means that the client has to synchronize the video streaming data with the scene files, as opposed to the synchronization that is taken care of, in the system shown in FIG. 1 by video server 30.

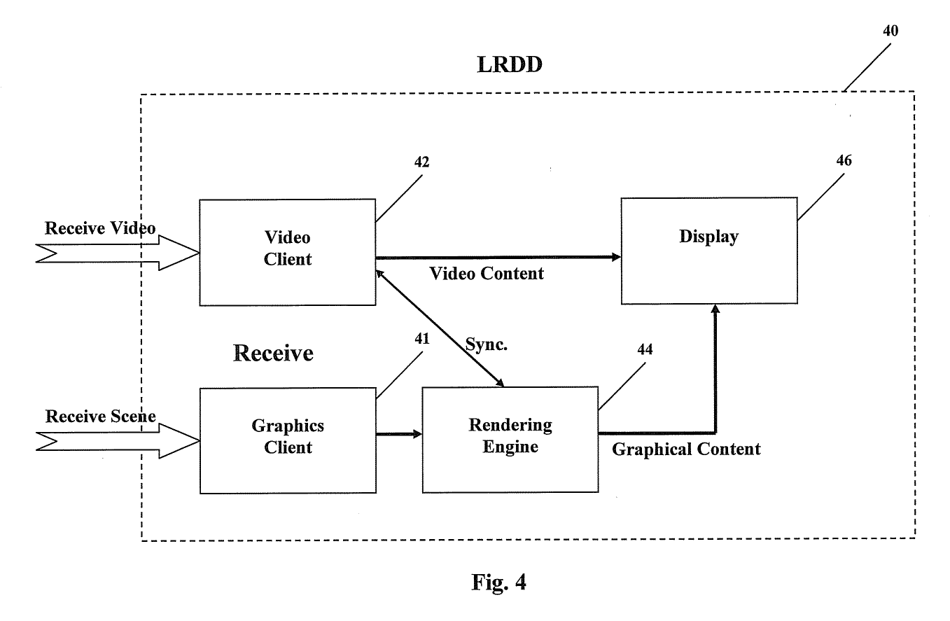

FIG. 4 illustrates an end-user LRDD adapted to cooperate with a system for generating graphical content, such as the system displayed in FIG. 3, according to another preferred embodiment of the present invention. In this embodiment the LRDD is provided with a video client 42 component, that receives the video streaming data and a graphic client 41 component that separately receives the scene files. The graphic client 41 sends the scene file to rendering engine 44, that renders the scene file to graphical content in synchronization to the video stream generated on the video client 42, so that both the video stream and the graphical content are displayed on display 46.

As the generated scene file was specifically designed for this particular type of LRDD, addressing its graphical characteristics, the graphical content is optimized in terms of quality and performance. This means, for example, that if the destination LRDD resolution is 320×200 the graphic content sent is specifically generated in this resolution. Similarly, if the supported languages of a destination LRDD are English and Hebrew, only subtitles in these languages are transmitted to that destination LRDD (in the appropriate resolution).

The system of the present invention is capable of producing scene files for different LRDD graphical characteristics, so that each type of LRDD is served the appropriate scene file for optimized display. Each end-user display device (LRDD) that signs up for this service is registered with the server, so that the server knows its specific device kind and hence its characteristics. Alternatively, the display characteristics of each device logged on to the service, or appearing on-line are considered.

Once an operator designs a scene layout the system of the present invention generates a plurality of scene files each suitable for display on a specific LRDD, depending on its graphical characteristics.

Note that for each set of graphical characteristics a scene file may be generated. This means, for example, that there may be several users with same type of device (for example NOKIA N70) with same display resolution and CPU capabilities but with different available memory, and in that case different scene files may be generated to optimize the display quality on each specific user device.

One way to achieve synchronization between the graphical and the video content, although they are streamed separately, is by inserting sync data on the video stream. Another way will be to send time code references along the graphical content; One knows, for example, that the graphics should appear on time-code 00:00:36:12, so the scene file is sent to the client, loaded into memory and the client tracks the time-code of the video clip which it displays it. As soon as the time-code arrives, the scene animation is played back.

In a preferred embodiment of the present invention, client oriented services can be achieved.

In order to accomplish that, a list of client characteristics is maintained at client characteristics database 24 (see FIG. 1). Client characteristics comprise, for example, preferred color schemes (which may be crucial for persons with color blindness), different graphic sizes (for persons with impaired vision), and preferred language. The system of the present invention is capable of generating customized scene files not only for specific graphical characteristics associated with LRDD devices, but also for specific clients according to a list of clients characteristics.

A client may be identified by detecting or registering the type of LRDD used, in which case the system will refer to the graphical characteristics of that particular type of LRDD, stored in database 20, when generating the scene file. If the client is personally identified, a personalized scene file is generated, also referring to the specific client characteristics stored in database 24.

The service of the present invention is resource efficient, the client is provided with a client application that is memory and CPU efficient, so as to minimize bandwidth usage.

The transmission method can be in “push” or “pull” mode. In “push” mode scenes are sent to all clients currently connected to the service (and logged to the service at the server). In “pull” mode the client, while watching a specific video stream content, such as soccer game, may generate a data request (“pull data”) from the host server, such as current score, and the system will send it to him automatically.

An operator (operating the control software 12 in FIG. 1) controls the graphical content layer that inserting the data according to the video content and events. For example, one may watch a football match on one's mobile phone screen (a client with LRDD) and one team scores a goal. An operator enters the score, hits enter, and a scene Generator (16 in FIG. 1) generates the appropriate scene file The graphic server (14 in FIG. 1), receives the trigger entered by the operator and sends the scene file to the client. One operator action, such as the above “enter” may automatically produce many different variations of scene files sent to different clients, depending on the capabilities of the various client devices.

The present invention suggests a mixed mode as well: push and pull. In one example one watches a football match on one's mobile phone display and the name of a player who has just scored is displayed on the lower third of the screen. The user may highlight the name thus requesting more information on that player, which is provided by the server. The push and pull mode is suitable for interactive applications.

Consider a cricket match. A match goes on for days, and many spectators do not watch all of it, rather watch portions of it. A client registered to the service of the present invention can have the score displayed on the client's display, and when there is a change in the score or when special events take place (the user may select specific “special events” to be alerted when these events take place) an alert is sent to the client. If interested the user can turn on his video service and watch the match.

Additional optional features may include:

Personalized advertisement, by simply referring to a user characteristics database (24 in FIG. 1) identifying the client and his/hers personal preferences and using this indication directing advertisements and commercial information to his taste;

Customized TV experience, by providing a variety of skins for on-air graphics, allowing each user to personalize his viewing experience. The user may be allowed to log into a web-site associated with the service of the present invention, and edit his profile;

Interactivity and voting applications, in pop-music popularity charts, the user may be provided with a scene of a selection menu (for example, in the form of an animated 3-dimensional scene) that lets the user select his favorite singer, and a voting message is sent back by the client application to the service server. Graphical content is produced, updated in real time, reflecting the current ranking.

As bandwidth is limited it is also desired to reduce information traffic and a main aspect of the present invention is the provision of a method for compact graphical content traffic.

The scene file generated by the server for display on the LRDD can be generally classified in two classes (explanation on the two classes is given hereinafter):

Base data, which is “skeleton” static data, such as station logo, scene general layout (e.g. position on the screen of a “foul” scene, position of elements of the scene on the screen, etc.-see explanation on “foul” scene hereinafter); also referred to in the present specification as “outline data”; “outline data” refers to all data that remains the same for this type of scene, e.g. foul animation, position of scene on the end-user LRDD screen, the word “foul” or corresponding graphical item, for example a short animation, the position of the number corresponding to the current number of fouls whistled against the player, the position of the player's name.

Dynamic data, which is data that changes occasionally (for example, new score), or data that is small enough to be resent (for example, the time in hours and seconds, that changes rapidly). Dynamic data is also referred to hereinafter as “specific data”.

“Scene data” refers to any part of the scene file, be it base data or dynamic data or any part thereof.

In principle the method of the present invention suggests generating a scene for an end-user LRDD of specific characteristics, and when the scene to be displayed on the LRDD is to be partly altered, sending only incremental data relating to the changes.

Consider a sport event, say a basketball match, which is broadcasted and a foul is whistled against a player. The producer of the broadcast signals the scene generator to generate a scene in which an animation is played and the player's name, his team name or logo, and the number of current fouls attributed to that player are displayed. If this is the first time a player makes a foul than the entire scene is transmitted for the first time and sent to the end-user LRDD for display. The end user LRDD displays the scene (and preferably retains the scene data).

As it is reasonable to expect that the same type of scene will be displayed again, only with different player's name, foul number, team name or logo, it is suggested to save the outline data on the end-user LRDD.

The next time another player makes a foul a “foul” scene is to be displayed on the end-user LRDD, but some of the scene information is not new: this is the same outline data as before—it is only the player's name, team name or logo and his foul number that are different than the data in the previous “foul” scene. This means that in principle only this information needs to be transmitted, while the “old” scene information—the outline data which was kept (cached or saved) on the end-user LRDD, can be reused.

A time display which consists of seconds may be sent repeatedly regardless of changes as the changes may be too fast for performing a request for information from the LRDD or checking the memory replica to determine the needed data (this is dynamic data that is too small or fast to be bothered with comparisons or information requests).

Therefore, according to a preferred embodiment of the present invention, several steps have to be performed to facilitate compact graphical content transmission:

In a “push” mode, the graphic server (or other device on the generating end) keeps track of the information already sent—this can typically be saving entire formerly broadcasted scenes or saving incrementally relevant information already transmitted (for example player names, number of fouls, team name or logo, etc.).

After the initial transmission of a scene, when generating another scene, the server checks if the scene particulars—all or some—have already been sent to that particular end-user LRDD. If so, than instead of sending the entire scene or the already transmitted data again, only the new data (hereinafter—incremental data) is sent.

On the end-user LRDD an application is placed, saving received scenes and using them or parts of them upon receipt of incremental updates.

In a “pull” mode, the end-user LRDD issues a request for a scene. This can be for example the case, when the owner of the end-user LRDD desires to get updated score. A scene file would be generated and the server will transmit only the required scene data.

The scene with latest score already displayed can be retrieved from the LRDD memory, and the LRDD local application may include a function assigned for retrieving current score, in which case he presses a predetermined key (or performs other assigned action). However, if the user has just joined and started viewing the broadcast than this information may not be currently available, so that a request is generated from the end-user LRDD causing the server to send the current score incremental update (which is a full scene, if the viewer has just joined the broadcast, or incremental update, if some elements of the scene have already been transmitted and received by that particular LRDD).

The operation mode, according to a preferred embodiment of the present invention, can be push, pull or both.

According to a preferred embodiment of the present invention, the incremental update is generated in one of the following three methods:

In a first method the server requests from the end-user LRDD to report status of what is stored in the LRDD memory. The server sends a request to the end-user LRDD to provide information on what scene data that is already present on the LRDD, and upon reply sends only incremental information that is new.

In yet another embodiment of the present invention, before the client starts downloading a scene file it downloads an inventory file describing the content of the scene file. This inventory file is typically smaller than the scene file itself. Using the inventory file the end-user LRDD can check what is already stored in the LRDD memory and send a download request to the server including descriptions for the server indicating which pieces of the scene data are missing on the LRDD side. The overhead of downloading the inventory file first is insignificant.

In another embodiment of the present invention, the server keeps a replica of each end-user LRDD memory (cached and/or saved), so that it does not have to rely on information requests from the LRDD. Based on preliminary knowledge of the specific LRDD characteristics (in particular memory type and size) and based on saved knowledge on the scene data already sent, the server can independently determine what incremental scene data needs to be sent to the LRDD.

The server and the client share the same mechanism that keep reusable data for future use, therefore the server can follow the current status of each LRDD user and optimize the communication to that device by sending only the needed data.

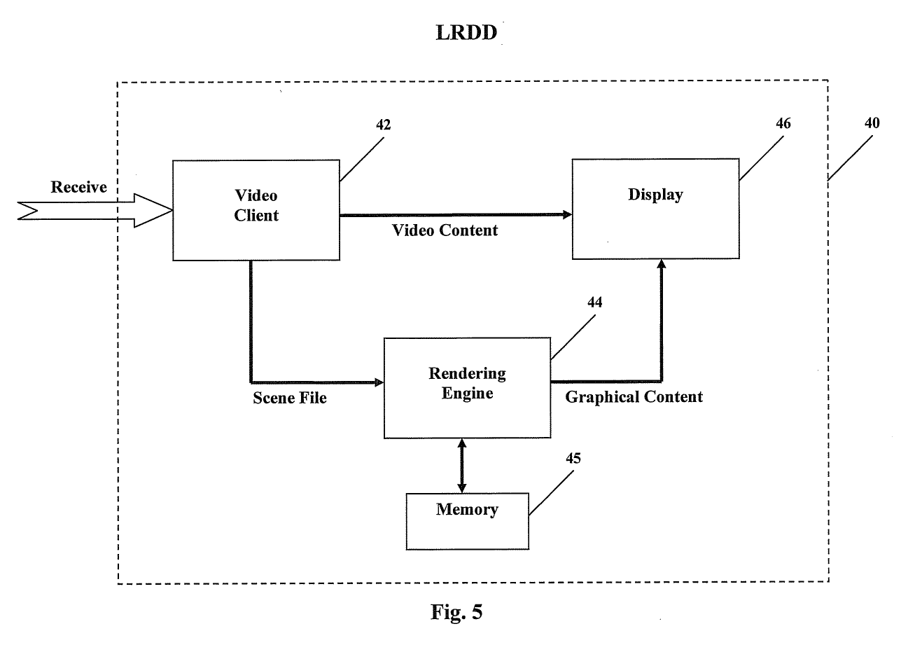

FIG. 5 illustrates an end-user LRDD (as shown in FIG. 2) adapted to cooperate with a system for generating compact graphical content according to a preferred embodiment of the present invention, with a memory 45 of specific type and size.

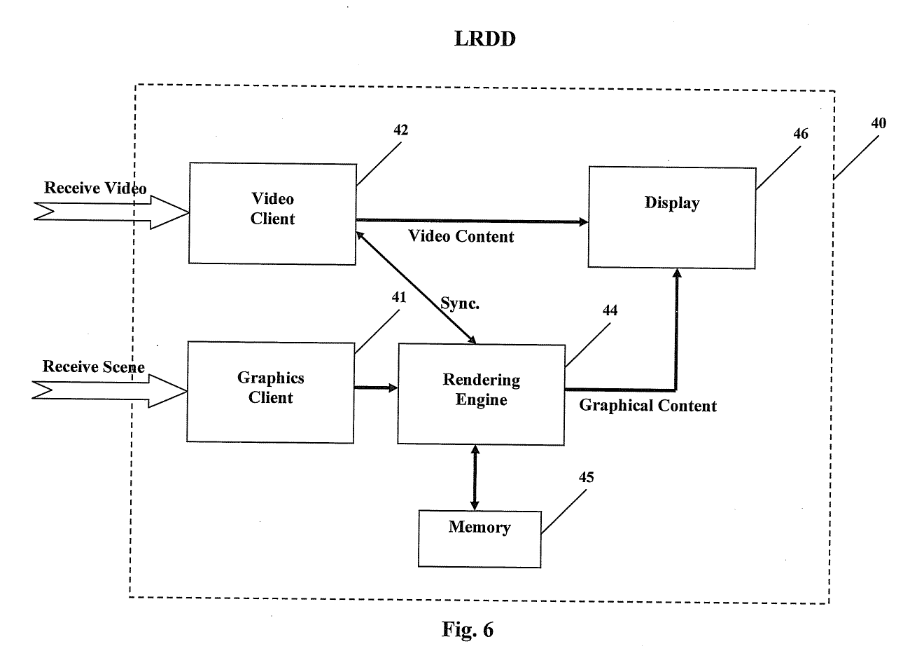

FIG. 6 illustrates an end-user LRDD (as shown in FIG. 4) adapted to cooperate with a system for generating compact graphical content according to a preferred embodiment of the present invention, with a memory 45 of specific type and size.

The devices of both embodiments (FIG. 5, FIG. 6) respond to a request from the server by sending information on the scene data already present on the LRDD memory 45 to the server, so as to allow the server to determine what additional incremental scene data needs to be sent to the LRDD.

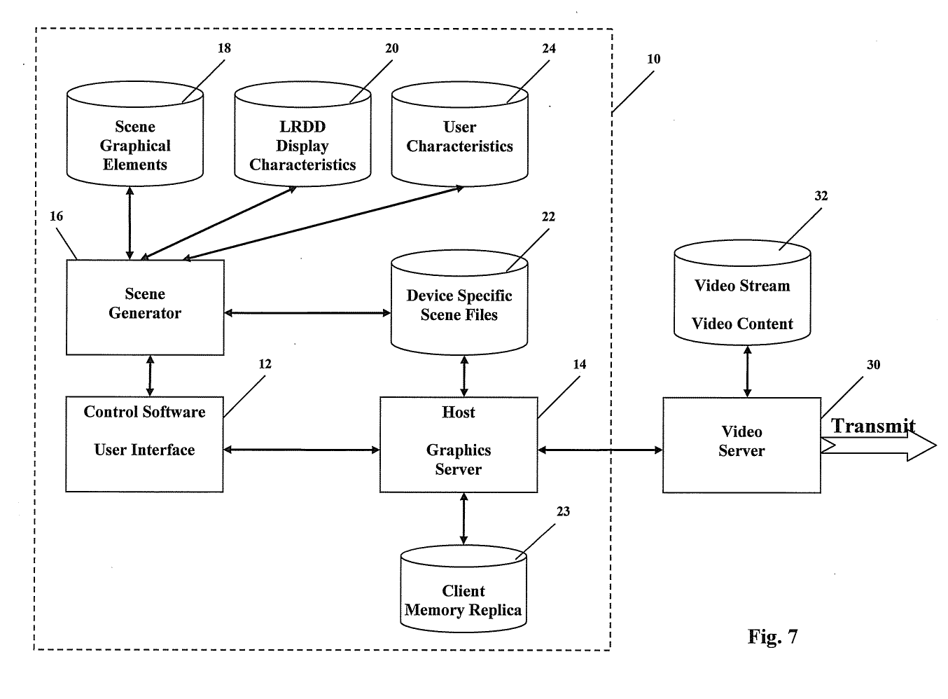

FIG. 7 illustrates a system (similar to the system shown in FIG. 1) for providing compact graphical data synchronized with video streaming data, designed to be displayed on a specific type of a display device, according to a preferred embodiment of the present invention, with client memory replica 23.

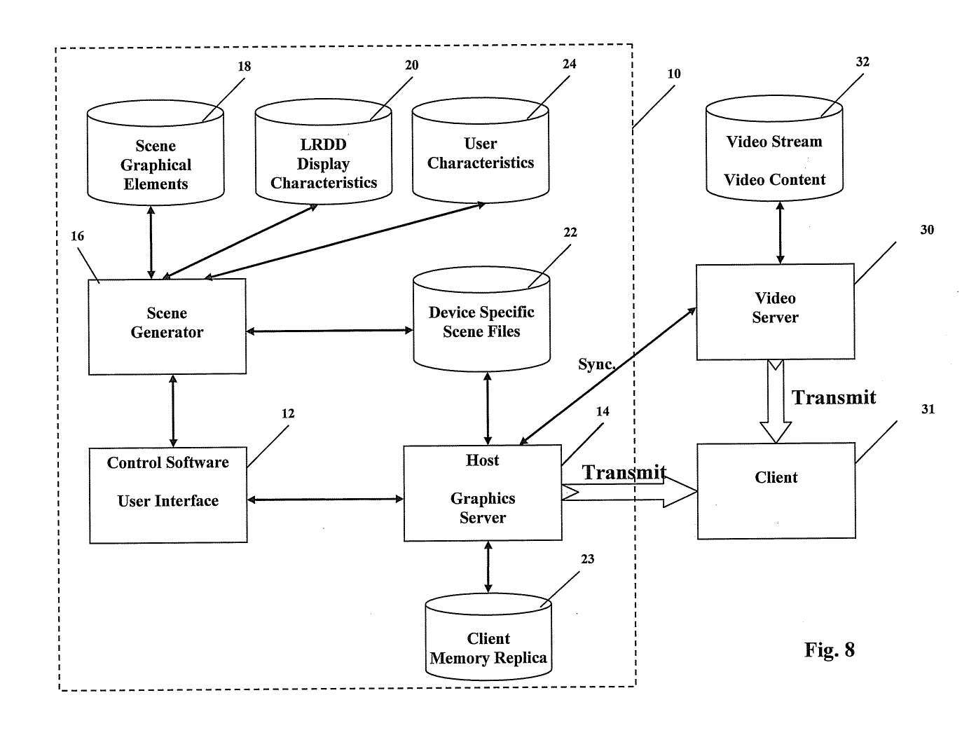

FIG. 8 illustrates a system (similar to the system shown in FIG. 3) for providing compact graphical data synchronized with video streaming data, designed to be displayed on a specific type of a display device, according to another preferred embodiment of the present invention, with client memory replica 23.

In the embodiments shown in FIG. 7 and FIG. 8, the server is independent in the sense that it does not request any information from the LRDD as it keeps track of the scene data available at the LRDD by maintaining a client memory replica 23 that is a mirror image of the memory of the specific LRDD, or has a record of all the scene data that has already been transmitted, and which is still present at the LRDD memory, this can be determined based on the knowledge of the client memory handling mechanism and based on a-priory knowledge of the specific LRDD memory type and size.

It should be clear that the description of the embodiments and attached Figures set forth in this specification serves only for a better understanding of the invention, without limiting its scope.

It should also be clear that a person skilled in the art, after reading the present specification could make adjustments or amendments to the attached Figures and above described embodiments that would still be covered by the present invention.

1. A method for compactly communicating a scene of graphical content from a server to a display device of known display characteristics, the scene comprising scene data, the method comprising determining if the scene data already exists at the display device, wherein if it is determined that the scene data already exists at the display device, refraining from communicating the scene data, wherein if it is determined that the scene data does not exist at the display device, communicating the scene data to the display device.

2. The method as claimed in claim 1, wherein the scene data comprises one or more increments of a greater scene data.

3. The method as claimed in claim 1, wherein the step of determining if the scene data already exists at the display device comprises:
requesting from the display device an indication on scene data that exists locally on the display device;
comparing the scene data with the scene data that exists locally on the display device to determine what scene data does not exist on the display device; and
communicating the scene data that does not exist on the display device to the display device.

4. The method as claimed in claim 1, wherein the step of determining if the scene data already exists at the display device comprises:
based on information on scene data already communicated to the display device that was previously saved, comparing the scene data with the information on the scene data that was saved to determine what portion of the scene data does not exist on the display device;
communicating the scene data that does not exist on the display device to the display device; and
saving information on the communicated scene data for future communication of scenes.

5. The method as claimed in claim 4, further comprising, based on the knowledge of the display characteristics the saved information on the communicated scene data, saving data corresponding specifically to the data which the display device maintains.

6. The method as claimed in claim 5, comprising maintaining a memory replica of a memory of the display device.

7. The method as claimed in claim 6, wherein the memory replica is based on knowledge of the LRDD characteristics.

8. The method as claimed in claim 7, wherein the memory replica is based on knowledge of the type and size of the memory of the display device.

9. The method as claimed in claim 1, wherein the scene data comprises outline data and specific data.

10. The method as claimed in claim 9, wherein the specific data is sent in increments.

11. The method as claimed in claim 1, wherein the step of determining if the scene data already exists at the display device comprises sending an inventory file describing the content of the scene, checking what is stored in the display device and sending a download request to the server indicating which portions of the scene data are missing on the display device.

12. A system for compactly communicating a scene of graphical content from a server to a display device of known display characteristics, the scene comprising scene data, the system comprising
a scene generator for generating the scene;
a processor for determining if the scene data already exists at the display device; and
a graphics server for transmitting the scene data to the display device if it is determined that the scene data does not exist at the display device, communicating the scene data to the display device.

13. The system as claimed in claim 12, wherein the scene data comprises one or more portions of a greater scene data.
